(19) United States
(12) Patent Application Publication
(10) Pub. No.: US 2024/0294349 A1
(43) Pub. Date: Sep. 5, 2024

(54) DEVICE FOR REMOVING OR SETTING ASIDE PRODUCT SEGMENTS FROM A PRODUCT FLOW IN THE ENERGY-CELL MANUFACTURING INDUSTRY

(71) Applicant: KÖRBER TECHNOLOGIES GMBH, Hamburg (DE)

(72) Inventors: Manfred FOLGER, Hamburg (DE); Jan KREYSERN, Hamburg (DE); Marcus WAGNER, Hamburg (DE); Michael KLEINE WÄCHTER, Lankau (DE); Karsten MEINKE, Mölln (DE); Nils HOFMANN, Ottersberg (DE); Patrick GÖGEL, Hamburg (DE)

(21) Appl. No.: 18/571,960

(22) PCT Filed: Jul. 7, 2022
(86) PCT No.: PCT/EP2022/068876

§ 371 Date: Dec. 19, 2023

(30) Foreign Application Priority Data
Jul. 12, 2021 (DE) 10 2021 207 346.8

(51) Int. Cl. B65H 29/58; B65H 29/24

(52) U.S. Cl. CPC B65H 29/585; B65H 29/243; B65H 2406/33; B65H 2801/72

(57) ABSTRACT

A device for removing or branching-off product segments from a product flow in the energy-cell manufacturing industry, characterised in that the device has at least one switchable dispenser which is set up to remove a product segment from the product flow as a result of a switch signal.

The present invention is in relation to a device for removing or branching-off product segments from a product flow in the energy-cell manufacturing industry.

Machines for producing battery cells using rotary driven drums are known for example from WO 2016/041713 A1, WO 2020/192845 A1 and DE 10 2017 216 213 A1.

It is desirable to be able to remove individual electrode sheets i.e., sliced anode or cathode sheets, individual separator sheets or individual monocells or separator electrode composite elements, in general individual web segments or product segments, from the production process, for example for quality testing, or to be able to check specific test criteria for correct recording by the internal machine sensor system, as well as for calibrating the sensor system as essential function when an on-line measuring device becomes operational. In addition, individual product segments with connection points, known as splices, which are product defects, should be targetedly removed from the production process to ensure that they do not reach the end product. The removal should be possible whist the production process is ongoing.

Additionally, switch points are required in the production machine at which a product flow of web segments or product segments, for example electrodes, separator sheets or monocells, can be separated into multiple possible paths.

The invention is therefore based on the object of providing a device for removing or branching-off flat product segments from a product flow in the energy-cell manufacturing industry.

The invention solves this object with the features of the independent claims.

According to the invention, the device has at least one switchable dispenser which is set up for removing a product segment from the product flow as a result of a switching signal.

The switching signal is output from a control device, for example from the machine controller. According to the invention, a switchable delivery or transfer of product segments from the production line is thus possible.

According to the invention, individual product segments, for example electrodes or separator bearings or individual monocells, can be removed from the production process. Thus, individual test criteria can be checked for correct recording by the internal sensor system. A check of the machine sensor systems is possible with little effort. Also, in this manner a calibration of such sensors is possible. Additionally, product segments with connection points, known as splices, can be targetedly removed from the production process, to ensure that splices do not reach the end product.

With product segments removed according to the invention, one or more of the following objects can be fulfilled: testing the internal sensor system by comparing the internal measurement values with externally calibrated measurement equipment; calibrating the internal sensor system; production removal for testing the ongoing quality; targeted splice removal for ensuring that this does not reach the end product.

The targeted removal of individual product segments thus enables a calibration of internal machine sensors. Furthermore, it enables the product quality to be checked quickly at essential process points, which would otherwise only be possible by time-consuming stopping and subsequent restarting of the machine.

Preferably, a removal device can lead the removed product segment through an airlock out of a climatically protected area. Thus, the production climate is only minimally disturbed, and a time-consuming (re)production of the necessary climate conditions can be avoided.

The machine can have one or several removal positions in the transport direction, wherein every removal position is preferably assigned a dispenser designed according to the invention, by which the intermediate products (segments) present at the respective production point can be removed.

Preferably, the device has a collecting device which can be arranged to receive a product segment removed from the product flow by the dispenser, for example below the dispenser.

In a preferred embodiment, the collecting device has at least one collection container which can be arranged in particular under the dispenser and which for example is removable from the machine manually or automatically. Thus, for each removal point a separate collection container can be provided. In an advantageous embodiment, the collecting device therefore comprises a plurality of collection containers that can be assigned in particular to different removal positions.

If a product segment to be discarded is detected for example by an operator, or automatically by a sensor, for example on detection of a splice, then a removal request is placed with the product tracking system in the control device. The corresponding product segment is then automatically discarded into the collection container by means of the dispenser. In one embodiment, the operator can then remove the collection container with the product segment.

Preferably, at least one portion of the collecting device, for example a collection container or a conveyor belt, is moveable, adjustable, displaceable or pivotable, in particular between different removal positions and/or out of a machine. As an alternative to multiple collection containers, a laterally displaceable device which can comprise a collection container or itself can be set up to receive discarded product segments can be provided below these removal points.

The collection container, or more generally a portion of the collecting device, is specifically moved under the removal point when there is a need for a removal and can for example wait there for product segments to be discharged. When the movable collection container reaches the removal point, it waits, for example, until the discarded product segment to be discarded passes by the removal point. The dispenser is then actuated, for example by an ejection valve, and the product segment is released or removed from the process flow. This can happen with or without compressed air, for example mechanically by means of a comb-out device. Subsequently, the products drop into another intermediate store (buffer device), described below, if necessary, or directly into the collection container or the collecting device. When all of the removed product segments to be removed have been removed, the collection container advantageously moves to a removal airlock of the machine. Then, for example, the discarded product segment is received here by the operator for further checking.

In an advantageous embodiment, the collecting device can comprise a conveying device, for example a conveyor belt. In the case of the use of a conveyor belt with a collection container, when there is a removal request this is sent to the collection container so that the latter can then move under the removal point.

In some embodiments it can be advantageous to provide a buffer device for the intermediate storage of removed product segments between the dispenser and the collecting device. From a time point of view, it can be advantageous to provide such a buffer device below every removal point, as the movement time of a movable collection container can be longer than the time for a product segment to be discarded to arrive at the collecting device.

In preferred embodiments, the removal device can have a holding device, for example a vacuum device, for applying a holding force, for example a suction force, on the product segment in the product flow. In this case, the switchable dispenser is set up advantageously for reducing or cancelling the holding force as a result of a switch signal.

In a practical preferred embodiment, the dispenser has at least one rotatably driven dispensing drum and the holding device, described above, is set up for holding and transporting at least one product segment by means of suction force on the lateral surface of the dispensing drum.

In this case, the switchable dispenser is set up advantageously to reduce or cancel the suction force as a result of a switch signal. On the basis of the reduced or cancelled suction force, the product segment found in the dispensing region of the dispenser can either fall from the dispenser due to gravity or be transferred a receiving device explained further below.

Preferably, the switchable dispenser has at least one switchable valve arranged in a vacuum device for interrupting the vacuum acting on a product segment. Due to the interruption of the vacuum supply, a product segment can be easily released from the product flow.

In different embodiments, a dispensing-side compressed air device, switchable by means of a valve for example, is provided for guiding compressed air to a dispensing point of the dispenser. In this variant, the vacuum existing at the dispensing point can be broken and neutralised by means of compressed air for dispensing a product segment.

The invention is likewise applicable to a device for branching-off product segments from a product flow in the energy-cell manufacturing industry. In this variant, the device advantageously has a rotatably driven dispensing drum which is set up to hold and transport a product segment by means of suction on the lateral surface of the dispensing drum, as well as a rotatably driven receiving drum having at least one vacuum sector which can be acted on with vacuum in order to hold or transport a product segment on the lateral surface of the receiving drum by means of suction. The device is advantageously controllable in such a way that, as a result of a switch signal for the transfer of a product segment, at least in a transfer region between the two drums, a higher suction force is produced on the receiving drum relative to the suction force produced on the dispensing drum.

Thus, the invention considers the essential functional principle of a transfer, which is based on the fact that the receiving side exerts a greater force on the product segment than the transferring side. This force difference is generated advantageously by different vacuum strengths. Therefore, the receiving drum is provided with a stronger vacuum pressure than the dispensing drum, for the purpose of transferring a product segment.

Preferably, for preventing a transfer for the purpose of further conveyance of a product segment to the dispensing drum, a receiving-side compressed air device which is switchable by means of a valve is provided for guiding compressed air to a receiving point of the receiving drum. The dispensing-side compressed air line and the receiving-side compressed air line are advantageously connected such that at any time, only one of the two compressed air lines applies compressed air to the assigned dispensing point or receiving point. By means of these two switch positions, a reliable switch point for the product segments in the machine can be realised.

According to the above, compressed air can be guided into both participating drums (dispensing drum and receiving drum) at the transfer point. However, only one side (dispensing side or receiving side) is acted upon with compressed air at any time. If the compressed air is applied to the receiving side, the vacuum is interrupted, and the product segment is transported further to the first drum (dispensing drum). If the compressed air is applied to the dispensing side, the vacuum is interrupted, and the product segment is transported further to the second drum (receiving drum).

The compressed air can, for example, be guided into the control bodies of the drums via a 3/2-way valve; each control body is then connected with an exit of the valve. The signal comes from the machine controller as to which position the valve is in. Thus, it is ensured that at all times only one side is supplied with compressed air. Multiple valves can also be provided to achieve the transfer, for example one valve for each drum (dispensing drum and receiving drum).

Preferably, the receiving drum has at least one suction pressure-free sector which does not have suction pressurisation or has a lower suction pressurisation relative to the suction on the dispensing drum. The rotational position of the receiving drum is preferably so controllable that the suction pressure-free sector is positionable in the transfer region for the further conveyance of a product segment onto the dispensing drum, and the vacuum sector can be positioned in the transfer region for the transfer of a product segment to the receiving drum. The invention considers with this feature that typically the vacuum level cannot be switched fast enough. The receiving drum is thus designed with at least one sector where the lateral surface is not supplied with a vacuum. As long as the product segments should be transported further on the first drum, the receiving drum is positioned in such a way that the sector which is not supplied with vacuum is facing the first one. However, if a product segment is to be acquired, the receiving drum is set in movement such that a region which is supplied with vacuum acquires the product segment.

The previously described aspect of the invention concerns switch points in the machine, at which the product flow of the product segments (composite units, monocells, electrode sheets or separator sheets) is separated into several possible paths. The decision of which product segment takes which path, is made, for example, in the machine controller, based on the properties or designs of the product segments. Since this division does not follow a fixed pattern, the transfer should be switchable at the switch points and should be activatable by the machine controller. The invention fulfils these requirements in the aforementioned manner.

A further aspect of the invention concerns a machine of the energy cell manufacturing industry, comprising at least one device according to one of the preceding claims and an electronic control device which is designed for the output of a switch signal when there is a removal demand or transfer demand for a product segment. Advantageously, a collecting device is provided for the machine. Preferably, at least one portion of the collecting device can be moved through a removal airlock out from the machine or extends through a removal air lock into the area surrounding the machine. After being filled, this portion of the collecting device (for example collection container or conveyor belt) travels to the central removal airlock. There only has to be one airlock opening in the machine therefore to remove removed product segments from the machine, so that the process climate is not unnecessarily disturbed within the machine.

The invention is explained in the following on the basis of preferred embodiments in relation to the appended figures. Here are shown:

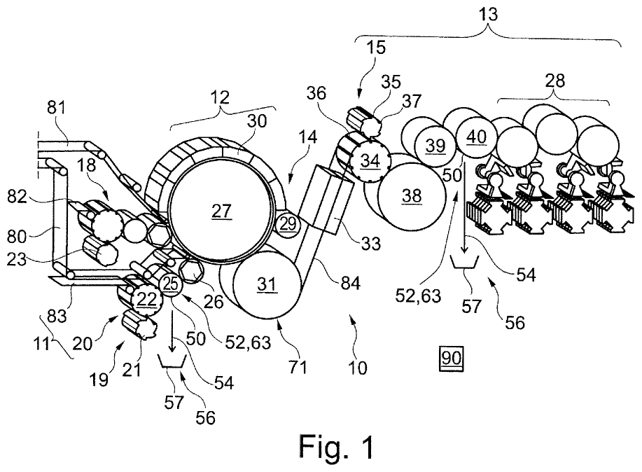

FIG. 1-3 a machine having several web segment removal positions with different embodiments of the collecting device;

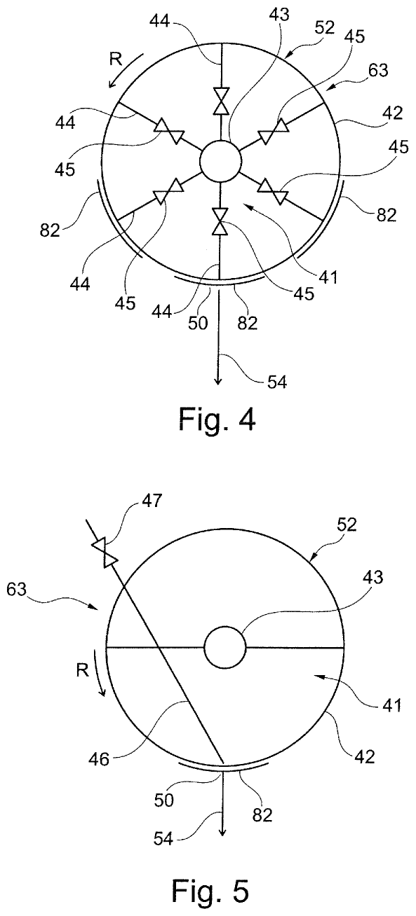

FIG. 4, 5 different embodiments of a web segment dispenser, and

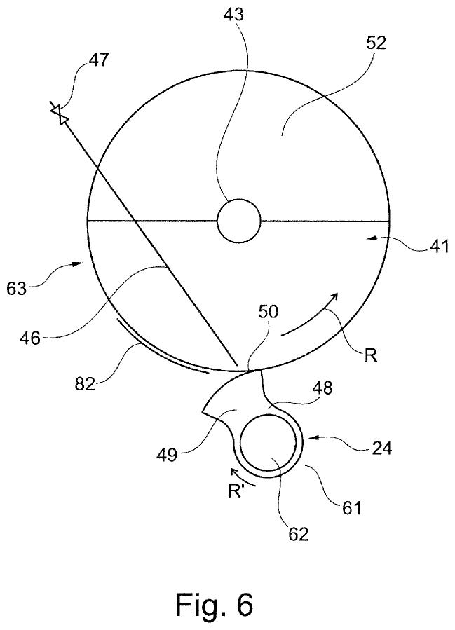

FIG. 6, 7 different embodiments of a product flow branching or product flow division device.

The machine 10 for producing cell stacks comprises a feed section 11 for feeding starting materials, namely substantially endlessly fed separator webs 80, 81 and electrodes or electrode sheets, namely anode and cathode sheets, to a subsequently arranged collecting and connecting section 12, in which the separator webs 80, 81 and electrodes are brought together and laid on each other. The collecting and connecting section 12 comprises a connecting device 14 which connects the materials laid on each other to each other to form an endless separator-electrode composite web 84. In the conveying direction downstream of the collecting and connecting section 12, a cut and stack portion 13 follows. This comprises a cutting device 15 for cutting the separator-electrode composite web 84 into individual composite units, for example monocells, and a stacking station 28 for stacking the composite units to form cell stacks.

The feed section 11 comprises electrode production sections 18, 19 for producing electrodes, specifically an anode production section 18 for producing individual anode sheets or anodes and a cathode production section 19 for producing individual cathode sheets or cathodes. The electrode production sections 18, 19 are preferably built in the same way. The cathode production section 19 is described below as an example.

The electrode production sections 18, 19 each have a cutting apparatus 20. The rotating cutting apparatus 20 serves to cut the endlessly fed electrode web, here the cathode web 83, into individual electrodes, here cathodes. The cutting apparatus 20 comprises a blade shaft 21 and a cutting drum 22. The blade shaft 21 is fitted along its periphery with blades. Corresponding grooves are provided on the cutting drum 22 around its periphery. The blade shaft 21 is arranged tangentially to the cutting drum 22. The rotational drives of the blade shaft 21 and the cutting drum 22 are coordinated so that a blade which goes into the contact region of the blade shaft 21 and the cutting drum 22, engages in a groove of the cutting drum 22 to cut the electrode web 83. The electrodes cut in this manner are further conveyed by means of vacuum from the cutting drum 22 and delivered onto a following transport drum 25. The electrodes are held on the transport drum 25 with vacuum and further conveyed by rotation. The separation changing drum 26 serves to provide the electrodes 95 with a spacing from each other in the longitudinal direction.

The cut electrodes and the uncut separator films 80, 81 are laid on the collection device 17, which is formed as a collection drum 27 here, in a defined order at different peripheral points. The material formation consisting of separator webs 80, 81 and electrodes laid in-between are further conveyed by the rotatably driven collection drum 27 and are connected to each other by means of a connecting device 14, here a laminating device with laminating roller 29, whereby a uniform, endless separator-electrode composite web 84 is produced. The result is therefore an endless web 84 made from cut and positioned electrodes which are connected by connection and/or lamination with the endless separator films 80, 81.

Outside on the periphery of the collector-/lamination drum 27, a heating device 30 can be provided. Subsequently, a cooling device 31, for example a cooling drum 71, can be provided for the separator-electrode composite web 84. Between the connecting device 14 and the cutting device 15, a check track 32 can be provided which has one or more checking devices 33, in particular for checking the positions of the anodes and cathodes in the connecting web 84.

The connecting web 84 is cut by means of the cutting device 15 into individual separator-electrode composite units, thereby creating monocells. The cutting device 15 is advantageously similarly built as the previously described cutting apparatus 20 and comprises preferably a cutting drum 34 with grooves 36, over which the composite web 84 is guided, and a blade roll 35 with blades 37 which cut the composite web 84 by engaging in the grooves 36.

The cutting and stacking section 13 preferably comprises a downstream checking drum 38 where the electrical characteristics of the individual composite units or monocells are measured by means of a corresponding checking device. Another transport drum 39 can be provided downstream of the checking drum 38. The cutting and stacking section 13 preferably comprise a discard drum 40 downstream of the at least one checking drum 38. Composite units or monocells 91 can be output from the discard drum 40, preferably downwards. This is explained in more detail later. The following drum system of the stacking station 28 serves to stack the composite units or monocells 91 to form cell stacks.

At one or more positions along the production flow in the machine 10, advantageously one or more removal points 50 are provided, at which product segments for example electrode sheets or separator-electrode composite units can be removed from the product flow, wherein each removal point is assigned a corresponding dispenser 63. The removal points 50 or the dispensers 63 are preferably arranged in the conveyance direction behind corresponding cutting positions. For example, a removal point 50 and a dispenser 63 are provided in the conveying direction, to remove and discard cut anodes from the product flow, behind the blade roller 21 which cuts the anodes. It is understood that a corresponding, not shown removal point and dispenser can be provided for removing and discarding cut cathodes from the product flow downstream from the blade roller 23 of the cathode production section 18. Advantageously, a removal point 50 and a dispenser 63 are provided to remove and discard cut composite units from the product flow, behind the blade roller 35, for cutting separator-electrode composite units, in the conveyance direction.

Each dispenser 63 is preferably implemented in a transport device, for example in a transport drum of the machine 10. Thus, a dispenser 63 is implemented in the transport drum 25 in FIG. 1, which can also be referred to as a dispenser drum 52. Similarly, the dispenser 63 is implemented in the discard drum 40, which likewise can be referred to as dispenser drum 52. The position of the respective dispensers 63 therefore in the product flow is variable and can for example be determined according to of the structural conditions. Thus, the electrode dispenser 63 can be implemented alternatively in the cutting drum 22 or the separation changing drum 26; the composite unit dispenser 63 can alternatively be implemented in one of the drums 34, 38 or 39. The removal positions also depend on the time management. For example, it has to guaranteed that the discard-generating information is already processed and as a result the dispenser can be actuated when the discarded product is guided past it. Generally, the removal points can be arranged at arbitrary positions in the machine and are not limited to the transport drum 25 or the discard drum 40 in FIG. 1.

The product segments 54 removed from the product flow fall, for example due to gravity, downwards from the dispenser drum 52 and are received by a collecting device 56. The collecting device 56 comprises preferably one or more collection containers 57 into which the removed product segments 54 fall by gravity. In the embodiment shown in FIG. 1, each removal point 50 or each dispenser 63 is assigned a corresponding collection container 57. The collection container or containers 57 are manually or automatically removable from the machine. For example, the collection container or containers 57 can be moveable, adjustable, displaceable or pivotable.

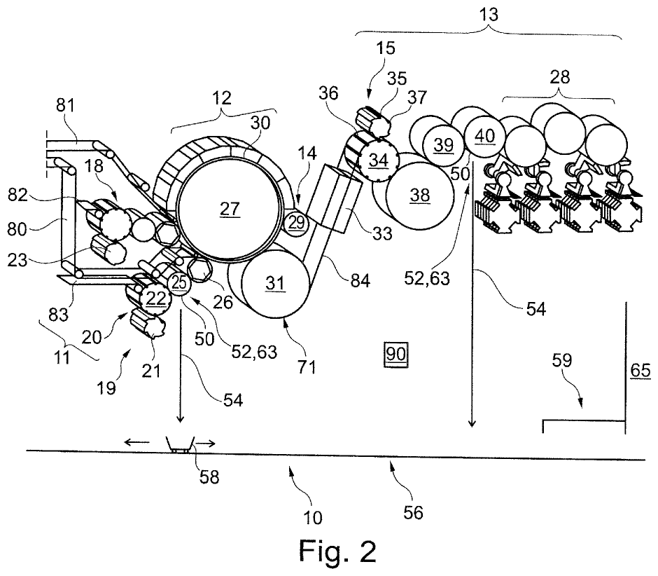

In the embodiment shown in FIG. 2, the collecting device 56 comprises a collection container 58, which is for example adjustable, moveable, or displaceable by means of an electric motor between several removal points 50. The fixed assignment between collection container and removal positions according to FIG. 1 has been cancelled here. The collection container 58 can be advantageously moved out from the machine 10 through an airlock 59, only shown schematically. Also, in this embodiment a plurality of moveable collection containers 58 can be provided to increase the removal capacity. A collection container 58 that has been moved out from the machine and emptied can, for example, move back into the machine 10 again on a circular path or in the opposite direction.

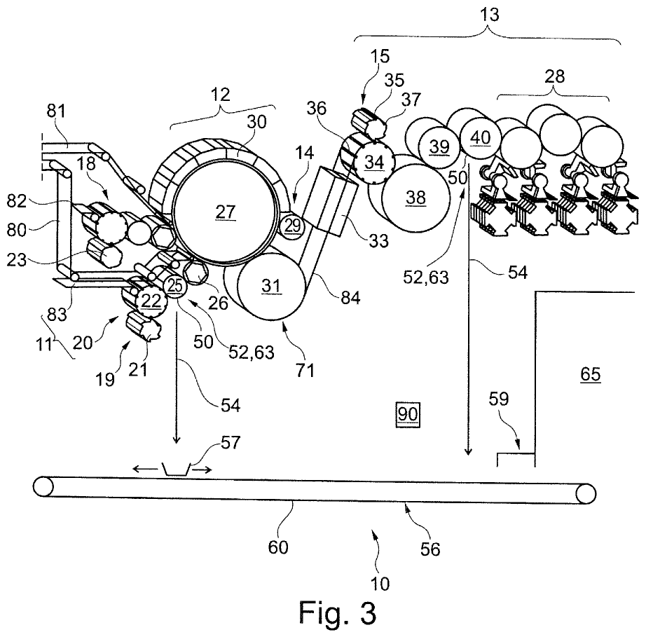

In the embodiment according to FIG. 3, the collecting device 56 comprises a driven conveying device 60, here for example an endless conveyor belt, which extends between several removal points 50 and/or through an airlock 59 into the area 65 surrounding the machine. One or more collection containers 57 can be provided on the conveyor belt. However, this is not mandatory, the conveying device 60 or the conveyor belt can also be set up without a collection container 57 to receive the removed product segments 54. Product segments 54 received by the conveying device 60 can be conveyed advantageously out of the machine 10 through the airlock 59.

In the following, different embodiments of the dispenser 63 for removing product segments from the product flow are explained with reference to FIGS. 4 and 5.

FIG. 4 exhibits an embodiment of a dispensing drum 52 which is rotatably driven in the rotational direction R and is set up to transport product segments 82 by means of vacuum. The dispensing drum 52 has for this purpose a vacuum device 41 which is set up to supply the lateral surface 42 of the dispensing drum 52, in order to hold product segments 82 thereon by means of suction. In the example in FIG. 4, the dispensing drum 52 has a division into six sectors corresponding to an angular distance of 60° between two product segments 82, with other divisions into more or less sectors being possible.

The vacuum device 41 comprises for example a central vacuum reservoir 43, which can be tubular for example, and vacuum lines 44 which connect the vacuum reservoir 43 with the lateral surface 42 of the dispensing drum 52. In each vacuum line 44, a switchable valve 45 is provided which is individually actuatable by a control device 90, for example the machine controller. The valves 45 are arranged in the rotating portion of the dispensing drum 52 and rotate following the drum casing 42 and with the product segments 82 held thereon.

To transport a product segment 82 in the product flow of the machine 10 from a first peripheral position (in FIG. 4 at 9 O'clock, for example), where the product segment 82 is transferred by an assigned conveying device, to a second peripheral position (in FIG. 4 at 3 O'clock, for example), where the product segment 82 is dispensed to a following conveying device, the assigned valve 82 is opened so that there is negative pressure on the corresponding portion of the lateral surface 42. To dispense the product segments 82 to the following assigned conveying device, the valve 45 is closed at the second peripheral position (for example, 3 O'clock) and afterwards is opened again before reaching the 9 O'clock position, in order to be able to receive another product segment 82.

In FIG. 4, the dispensing drum 52 has a discard or dispense position 50 for example at 6 O'clock. When a particular product segment 82 should be removed from the product flow, the control device 99 controls the corresponding valve 45 as a result of a discard request by means of a switch signal if the product segment 82 to be removed has reached the dispense position 50 in order to close the corresponding valve 45. On the basis of a lack of vacuum at the dispense position 50, suction is no longer exerted on the product segment 82 to be removed, this can fall down by means of gravity and thus be removed from the product flow. The valve 45 is opened again before reaching the 9 O'clock position in order to be able to receive another product segment 82.

In FIG. 4, product segments 82 which should be discarded can therefore be disconnected from the vacuum supply once they go past a specific peripheral position (here 6 O'clock) and in this manner securely removed from the dispenser drum 52.

A further embodiment of a dispensing drum 52 is shown in FIG. 5. Here a vacuum device 41 is also provided, in order to hold and transport product segments 82 on the lateral surface of the dispensing drum 52 by means of suction. The vacuum device 41 here can be designed in the shape of one or more spatially fixed sectors. In the present example, the vacuum sector extends in the lower half of the dispensing drum 52 between 9 O'clock (transfer from an upstream conveying device) and 3 O'clock (transfer to a downstream conveying device).

Furthermore, a spatially fixed compressed air supply line 46 is provided having a switchable valve 47 arranged within, wherein the compressed air supply line 46 leads to or into the region of the removal position 50. The valve 47 in the compressed air supply line 46 is closed in the normal production operation. When a product segment 82 is to be discarded from the dispensing drum 52, the control device 90 controls the valve 47 to open it. The compressed air then flowing out from the opening of the compressed air supply line 46 breaks or neutralises the vacuum produced by the vacuum device 41 locally at the removal position 50 so that the suction on the product segment 82 is cancelled and the product segment 82 can fall out of the product flow downwards by means of gravity.

The embodiments described with reference to FIGS. 4 and 5 can be modified simply, so that, instead of discarding a product segment 82, branching or dividing a product flow into two sub-streams can be achieved, i.e. a product switch point in the machine 10. This is explained below using FIG. 6.

In FIG. 6 the dispenser 63 as designed in FIG. 5, is supplemented with a receiving device 24 having a receiving drum 48 which is arranged tangentially to the dispensing drum in the region of the dispensing position 50 of the dispensing drum 52. The receiving drum 48 is preferably executed as a segment drum and has a vacuum sector 49 in a first peripheral section, for example in the form of a cam, which extends here, for example, approximately 50°, and a vacuum-free sector 61 in a second section which here extends for the remaining 310°, for example. The vacuum sector 49 is, for example, supplied via the central vacuum reservoir 62 with vacuum.

In a first switch position which is not shown in FIG. 6, the rotational position of the receiving drum 48 is adjusted so that the vacuum sector 49 is turned away from the dispensing drum 52 and thus is not operatively linked with the dispensing drum 52. At this switch position, the vacuum-free sector 61 of the receiving drum 48 is thus in the region of the dispensing position 50 of the dispensing drum 52. The receiving drum 48 is thus functionless and the product segments 82 held on the dispensing drum 52 and passing through the dispensing position 50 are further conveyed on the dispenser drum 52, here for example to 3 O'clock (first sub-stream).

To branch off product segments 82, the vacuum sector 49 of the receiving drum 48 is pivoted in the rotational direction R′ into the region of the dispensing position 50 of the dispensing drum 52 (see FIG. 6). As soon as the vacuum sector 49 is tangential to the dispensing drum 52, the valve 47 is opened by the control device 90 and the dispensing position 50 is acted upon by compressed air in order to break the vacuum produced there by the vacuum device 41. Since the dispensing drum 52 does not exert suction on the product segment 82 in the dispensing position 50 anymore, it is drawn in and received by the vacuum sector 49 of the receiving drum 48. Due to the further pivoting of the receiving drum 48 or of the vacuum sector 49, product segment 82 is further conveyed and can be dispensed to a conveying device (not shown) downstream of the receiving drum 48 (second sub stream).

In FIG. 6, the vacuum of the dispensing drum 52 is broken or neutralised by means of compressed air to dispense a product segment 82 to the receiving drum 48. In general, the vacuum of the dispensing drum 52 does not need to be reduced to zero to dispense a product segment 82. In general, it is sufficient for the transfer when the vacuum of the receiving drum 48 exerts stronger suction force on the product segment 82 than the vacuum of the dispensing drum 52.

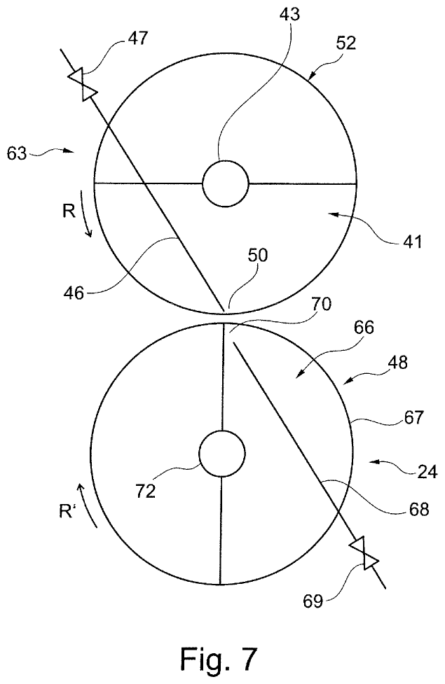

A further embodiment for a device for branching off or dividing a product flow into two sub-streams i.e., a product switch point in the machine 10, is shown in FIG. 7. Here, the dispenser 63 is also designed as the receiving device 24 as in FIG. 5. The receiving drum 48 likewise has a vacuum device 66 supplied with negative pressure from a vacuum reservoir 72, in order to hold and transport product segments 82 on the lateral surface 67 of the receiving drum 48 by means of vacuum. The vacuum device 66 here can be designed in the shape of one or more spatially fixed sectors. In the present example, the vacuum sector extends in the right half of the receiving drum 48 between 12 O'clock (if necessary, acquired by the dispensing drum 52) and 6 O'clock (transfer to a conveying device arranged downstream). Furthermore, a spatially fixed compressed air supply line 68 is provided having a switchable valve 69 arranged therein, wherein the compressed air supply line 68 leads to or into the region of a receiving position 70 of the receiving drum 48.

The control device 90 controls the valves 47, 69 so that, at any point in time, one of the valves 47, 69 is open and the other valve 69, 47 is closed. When the valve 69 is open and the valve 47 is closed (first switch position), the compressed air emerging from the compressed air supply line 68 breaks the vacuum produced by the vacuum device 66, which switches the receiving drum 48 to functionless and the product segments 82 held on the dispensing drum 52 passing through the dispensing position 50 are further conveyed to the dispensing drum 52, here for example to 3 O'clock (first sub-stream). If, however, the valve 47 is open and the valve 69 is closed (second switch position), the compressed air coming from the compressed air supply line 46 breaks the vacuum produced by the vacuum device 41. Since the dispensing drum 52 does not exert suction on the product segment 82 in the dispensing position 50 anymore, it is drawn in by the receiving drum 48 supplied with the vacuum, acquired, and conveyed further, here for example to 6 O'clock (second sub-stream).

In further embodiments, a device for branching off or dividing a product flow can be produced alternatively based on the dispenser 63 designed according to FIG. 4 by the addition of a receiving device 24 as designed in FIG. 6 or FIG. 7.

In the embodiment according to FIGS. 4 to 7, the central element of the dispenser 63 has been described is the form of a dispensing drum 52. Other designs are possible, for example in the form of a dispenser-conveyor belt. The same goes for the design of the receiving device 24.

1. A device for removing or branching-off product segments from a product flow in the energy-cell manufacturing industry, characterised in that the device has at least one switchable dispenser which is set up to remove a product segment from the product flow as a result of a switch signal.

2. The device according to claim 1, wherein the device has a collecting device that can be arranged to receive a product segment removed from the product flow by the dispenser.

3. The device according to claim 2, wherein the collecting device has at least one collection container that can be arranged below the dispenser.

4. The device according to claim 2, wherein at least one portion of the collecting device is moveable, adjustable, displaceable or pivotable, between different removal positions and/or out from a machine.

5. The device according to claim 2, wherein the collecting device comprises a conveying device.

6. The device according to claim 2, wherein the collecting device comprises a plurality of collection containers which can be assigned to different removal positions.

7. The device according to claim 2, wherein a buffer device for intermediate storage of the removed product segments is provided between the dispenser and the collecting device.

8. The device according to claim 1, wherein the device has a holding device for exerting a holding force on the product segment in the product flow, wherein the switchable dispenser is set up to reduce or cancel the holding force as a result of a switch signal.

9. The device according to claim 1, wherein the dispenser has at least one rotatably driven dispensing drum and the holding device is set up to hold and transport at least one product segment by means of suction force on the lateral surface of the dispensing drum, wherein the switchable dispenser is set up to reduce or cancel the suction force as a result of a switch signal.

10. The device according to claim 9, wherein the switchable dispenser has at least one switchable valve arranged in a vacuum device for interrupting the vacuum acting upon a product segment.

11. The device according to claim 1, wherein a dispensing-side compressed air device which is switchable by means of a valve is provided for guiding compressed air to a dispensing point of the dispenser.

12. The device according to claim 1 for branching-off product segments from a product flow in the energy-cell manufacturing industry, wherein the device has a rotatably driven dispensing drum which is set up to hold and transport a product segment by means of suction force on the lateral surface of the dispensing drum, and a rotatably driven receiving drum having at least one vacuum sector which can be acted upon with vacuum in order to hold and transport a product segment on the lateral surface of the receiving drum by means of suction force, wherein the device is controllable such that, as a result of a switch signal for transferring a product segment, at least in a transfer region between both drums a higher suction force is generated on the receiving drum in relation to the suction force on the dispensing drum.

13. The device according to claim 12, wherein, to avoid a transfer for the purpose of further conveyance of a product segment on the dispensing drum, a receiving-side compressed air device which is switchable for example by means of a valve is provided for guiding compressed air to a receiving point of the receiving drum.

14. The device according to claim 11, wherein the dispensing-side compressed air device and the receiving-side compressed air device are connected so that only one of the two compressed air lines applies compressed air to the associated dispensing point or receiving point at any one point in time.

15. The device according to claim 12, wherein the receiving drum has at least one suction pressure-free sector which does not have suction pressurisation or has a lower suction pressurisation relative to the suction force on the dispensing drum.

16. The device according to claim 15, wherein the rotational position of the receiving drum is controllable in such a way that the suction pressure-free sector can be positioned in the transfer region for the further conveyance of a product segment on the dispensing drum, and the vacuum sector can be positioned in the transfer region for the transfer of a product segment at the receiving drum.

17. A machine of the energy-cell manufacturing industry, comprising at least one device according to claim 1 and an electronic control device which is designed for the output of a switch signal when there is a removal demand or transfer demand for a product segment.

18. The machine according to claim 17 having a device for removing or branching-off product segments from a product flow in the energy-cell manufacturing industry, wherein the device has at least one switchable dispenser that is set up to remove a product segment from the product flow as a result of a switch signal, and wherein the device has a collecting device that can be arranged to receive a product segment removed from the product flow by the dispenser; wherein at least one portion of the collecting device is displaceable out from the machine through a removal airlock of the latter or extends through a removal airlock into the area surrounding the machine.

19. The device according to claim 12, wherein the dispensing-side compressed air device and the receiving-side compressed air device are connected so that only one of the two compressed air lines applies compressed air to the associated dispensing point or receiving point at any one point in time.

20. The device according to claim 14, wherein the receiving drum has at least one suction pressure-free sector which does not have suction pressurisation or has a lower suction pressurisation relative to the suction force on the dispensing drum.
